(19) United States
(12) Patent Application Publication
(10) Pub. No.: US 2026/0245795 A1
(43) Pub. Date: Aug. 20, 2026

(54) MULTILAYER ELECTRONIC COMPONENT

(71) Applicant: SAMSUNG ELECTRO-MECHANICS CO., LTD., Suwon-si (KR)

(72) Inventors: Jin Hwan KIM, Suwon-si (KR); Yoo Jeong PARK, Suwon-si (KR); Seung Hun BAEK, Suwon-si (KR); Myung Duk SEO, Suwon-si (KR); Ho In JUN, Suwon-si (KR)

(73) Assignee: SAMSUNG ELECTRO-MECHANICS CO., LTD., Suwon-si (KR)

(21) Appl. No.: 19/531,200

(22) Filed: Feb. 5, 2026

(30) Foreign Application Priority Data
Feb. 19, 2025 (KR) 10-2025-0021759

(51) Int. Cl. H01G 4/20; H01G 4/008; H01G 4/012; H01G 4/18; H01G 4/30

(52) U.S. Cl. CPC H01G 4/20; H01G 4/008; H01G 4/012; H01G 4/18; H01G 4/30

(57) ABSTRACT

A multilayer electronic component according to an embodiment of the present disclosure includes: a body including a dielectric layer and an internal electrode; and an external electrode disposed on the body; wherein the dielectric layer may include a plurality of dielectric particles and a polyvinylidene fluoride (PVDF)-based polymer. The dielectric layer may include the PVDF-based polymer in an amount of more than 0 and less than 42.86 parts by weight based on 100 parts by weight of the dielectric particles.

### CROSS-REFERENCE TO RELATED APPLICATION(S)

This application claims benefit of priority to Korean Patent Application No. 10-2025-0021759 filed on Feb. 19, 2025 in the Korean Intellectual Property Office, the disclosure of which is incorporated herein by reference in its entirety.

### TECHNICAL FIELD

The present disclosure relates to a multilayer electronic component.

### BACKGROUND ART

A multilayer ceramic capacitor (MLCC), a multilayer electronic component, is a chip-type condenser, mounted on the printed circuit boards of various types of electronic product, such as image display devices including a liquid crystal display LCD and a plasma display panel PDP, computers, smartphones and mobile phones, and serves to charge or discharge electricity therein or therefrom.

Such multilayer ceramic capacitors may be used as a component in various electronic devices due to having a small size, ensuring high capacitance and being easily mounted. As various electronic devices, such as computers and mobile devices, or the like, become smaller and have higher output, demand for miniaturization and high capacitance of multilayer ceramic capacitors is increasing.

Meanwhile, in multilayer ceramic capacitors for automotive applications, it is important to maintain high reliability under harsh environments. For example, multilayer ceramic capacitors are required to have excellent bending strength and impact resistance. To this end, bending strength characteristics are being improved by methods adding various materials to the multilayer electronic component, modifying its structure, or the like.

### DISCLOSURE

### Technical Problem

One of many problems to be solved by the present disclosure is to provide a multilayer electronic component having excellent bending strength characteristics and impact resistance.

One of many problems to be solved by the present disclosure is to provide a miniaturized multilayer electronic component.

One of many problems to be solved by the present disclosure is to provide a multilayer electronic component with simplified manufacturing processes and reduced manufacturing costs.

However, the many problems to be solved by the present disclosure are not limited to the above, and will be more easily understood in the process of describing specific embodiments of the present disclosure.

### Brief Summary and Solution to Problem

A multilayer electronic component according to an embodiment of the present disclosure may include: a body including a dielectric layer and internal electrodes; and external electrodes disposed on the body, wherein the dielectric layer may include a plurality of dielectric particles and a polyvinylidene fluoride (PVDF)-based polymer.

### Advantageous Effects

One of many effects of the present disclosure is to improve bending strength characteristics and impact resistance of the multilayer electronic component.

One of many effects of the present disclosure is to miniaturize the multilayer electronic component.

One of many effects of the present disclosure is to simplify a manufacturing process and reduce manufacturing costs of the multilayer electronic component.

However, the various advantageous effects of the present disclosure are not limited to the above, and will be more easily understood in the process of describing specific embodiments of the present disclosure.

### BRIEF DESCRIPTION OF DRAWINGS

FIG. 1 schematically illustrates a perspective view of a multilayer electronic component according to an embodiment of the present disclosure.

FIG. 2 schematically illustrates a cross-sectional view taken along line I-I′ of FIG. 1.

FIG. 3 schematically illustrates a cross-sectional view taken along line II-II′ of FIG. 1.

FIG. 4 schematically illustrates dielectric particles and PVDF-based polymers.

FIG. 5 is an image of a cross-section of a dielectric layer of an embodiment of the present disclosure observed by using a field emission scanning electron microscope (FE-SEM).

FIG. 6 is a graph of dielectric characteristics according to a weight ratio of dielectric particles and PVDF-based polymer.

### DETAILED DESCRIPTION

Hereinafter, embodiments of the present disclosure will be described with reference to specific embodiments and the accompanying drawings. However, embodiments of the present disclosure may be modified to have various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components with the same reference numerals. Further, throughout the specification, when an element is referred to as “comprising” or “including” an element, it means that the element may further include other elements as well, without departing from the other elements, unless specifically stated otherwise.

In the drawings, a Z-direction may be defined as a thickness direction or a first direction, an X-direction as a length direction or a second direction, and a Y-direction as a width direction or a third direction. Additionally, a stacking direction may be a thickness direction or a width direction.

In addition, in the present disclosure, a thickness may refer to a size in the first direction, a length may refer to a size in the second direction, and a width may refer to a size in the third direction.

### Multilayer Electronic Component

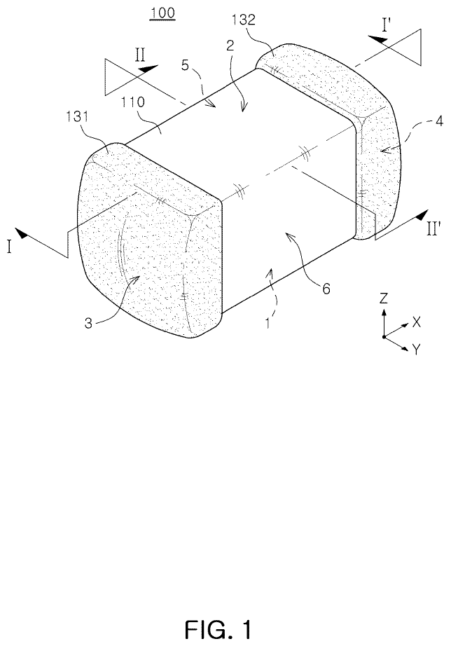

FIG. 1 schematically illustrates a perspective view of a multilayer electronic component according to an embodiment of the present disclosure.

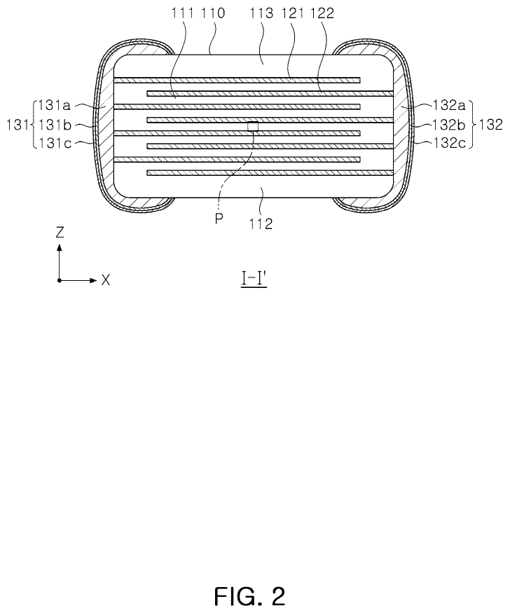

FIG. 2 schematically illustrates a cross-sectional view taken along line I-I′ of FIG. 1.

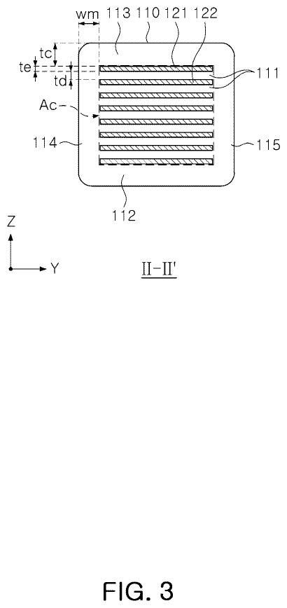

FIG. 3 schematically illustrates a cross-sectional view taken along line II-II′ of FIG. 1.

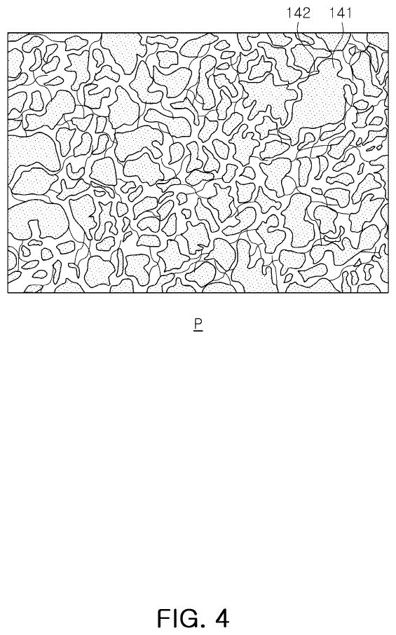

FIG. 4 schematically illustrates dielectric particles and PVDF-based polymers.

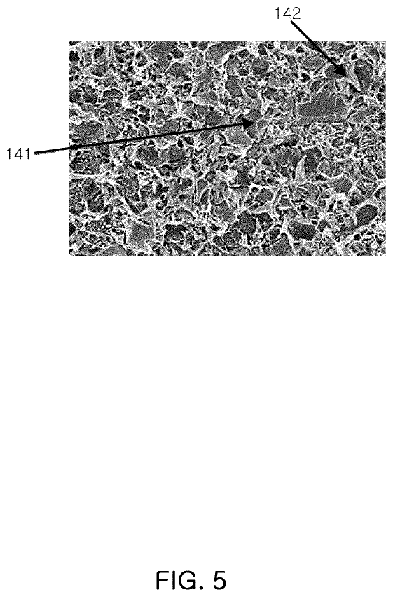

FIG. 5 is an image of a cross-section of a dielectric layer of an embodiment of the present disclosure observed by using a field emission scanning electron microscope (FE-SEM).

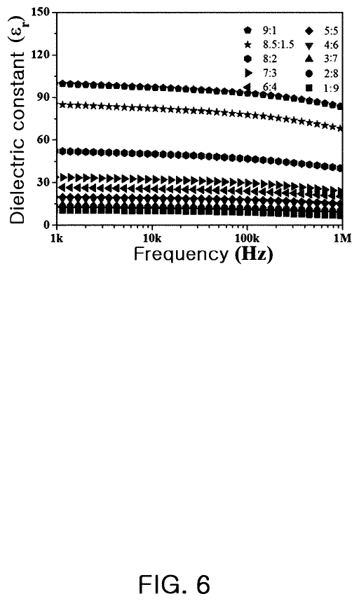

FIG. 6 is a graph of dielectric characteristics according to a weight ratio of dielectric particles and PVDF-based polymer.

Hereinafter, a multilayer electronic component according to an embodiment of the present disclosure will be described in detail with reference to FIGS. 1 to 4. However, as an example of a multilayer electronic component, a multilayer ceramic capacitor is described, but the present disclosure may also be applied to various electronic products using a dielectric composition, such as inductors, piezoelectric elements, varistors, or thermistors.

A multilayer electronic component 100 according to an embodiment of the present disclosure may comprise: a body 110 including a dielectric layer 111 and internal electrodes 121 and 122; and external electrodes 131 and 132 disposed on the body 110; wherein the dielectric layer 111 may include dielectric particles 141 and a Polyvinylidene fluoride PVDF-based polymer 142.

The body 110 may have a dielectric layer 111 and internal electrodes 121 and 122 alternately stacked.

More specifically, the body 110 may include a capacitance formation portion Ac forming a capacitance, including a first internal electrode 121 and a second internal electrode 122 that are disposed alternately to oppose each other with a dielectric layer 111 interposed therebetween, the electrodes being disposed inside the body 110.

There is no particular limitation on the specific shape of the body 110, but as illustrated, the body 110 may have a hexahedral shape or a shape similar thereto. Due to shrinkage of the ceramic particles included in the body 110 during a sintering process, the body 110 may not have a hexahedral shape with entirely straight lines, but may have a substantially hexahedral shape.

The body 110 may have first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction.

A plurality of dielectric layers 111 forming the body 110 are in a sintered state, such that boundaries between adjacent dielectric layers 111 may be integrated so as to be difficult to identify without using a scanning electron microscope (SEM).

The raw material of the dielectric particles 141 included in the dielectric layer 111 is not limited as long as sufficient electrostatic capacitance can be obtained. In general, perovskite ABO₃-based materials may be used, for example, barium titanate-based materials, lead composite perovskite-based materials, or strontium titanate-based materials may be used. The barium titanate-based material may include BaTiO₃-based ceramic particles, and examples of the ceramic particles include BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1), in which calcium Ca, zirconium Zr, etc. are partially dissolved.

In addition, the raw material for forming the dielectric particles 141 may be ceramic particles such as barium titanate BaTiO₃, to which various ceramic additives, organic solvents, binders, dispersants, or the like, may be added according to the purpose of the present disclosure.

In the present disclosure, the dielectric layer 111 may include dielectric particles 141 and Polyvinylidene fluoride PVDF-based polymer.

The presence or absence of dielectric particles 141 and PVDF-based polymer 142 may be confirmed through peak analysis using an X-ray diffractometer XRD, a method for observing the dielectric particles 141 and the PVDF-based polymer 142 may be achieved by observing the cross-section of the length and thickness direction of the body 110 using a field emission scanning electron microscope (FE-SEM), and may be observed as in [FIG. 5], which is an embodiment of the present disclosure, but is not particularly limited thereto.

The dielectric particle 141 does not mean a general grain formed by sintering and/or firing ceramic particles, but may be obtained in a pulverized state (or pulverized grains) by producing a bulk dielectric through firing and then pulverizing it again. Since grains are obtained by independently forming particles of the desired size through grain growth from initially small seed particles, the dielectric constant may be reduced due to surface defects, or the like. That is, in the case of ceramic particles having a free surface, there may be many defects on the surface, and it may be difficult to secure sufficient capacitance when mixed with the PVDF-based polymer 142 described later unless a separate additional additive is added. Accordingly, it may be desirable to obtain dielectric particles 141 by using a method of forming a dielectric microstructure through sintering and then re-pulverizing to secure appropriate insulating characteristics.

That is, the dielectric particles 141 included in the dielectric layer 111 may be in a pulverized form, may have a shape somewhat different from that of conventional grains, and may be in plurality numbers. In addition, since dielectric characteristics are implemented by mixing ceramic particles and various additives and performing sintering and/or firing, dielectric particles having a core-shell structure may be included.

In addition, since the dielectric particles 141 are in a pulverized form after sintering and/or firing, there may be no need to perform a separate firing process after mixing with the PVDF-based polymer, and even if heat treatment is performed, it may be preferable to perform the heat treatment at a temperature of about 200° C. or lower at which the PVDF-based polymer does not decompose.

And, a major axis length of the dielectric particle 141 may be 50 nm or more and 1000 nm or less.

The major axis length of the dielectric particle 141 may be obtained by measuring the longest length passing through the center of the dielectric particle 141 when observing the dielectric particle 141 through a field emission scanning electron microscope (FE-SEM), but is not particularly limited thereto. Other methods and/or tools appreciated by one of ordinary skill in the art, even if not described in the present disclosure, may also be used.

The dielectric layer 111 may include the PVDF-based polymer 142 and may be disposed between adjacent dielectric particles 141.

The PVDF-base polymer 142 has excellent dielectric constant and viscoelasticity, so it may complement and improve the dielectric characteristics of the multilayer electronic component 100, while also relieving external stress and improving bending strength.

As a specific example of the PVDF-based polymer 142, it may include at least one of PVDF Homopolymer; PVDF-HFP (Hexafluoropropylene); PVDF-TrFE (Trifluoroethylene); PVDF-CTFE (Chlorotrifluoroethylene); PVDF-TFE (Tetrafluoroethylene); surface-modified PVDF including at least one of PVDF-g-PEG (Polyethylene Glycol) and PVDF-g-PS (Polystyrene); Fluoroelastomer-based PVDF; PVDF-nanocomposite including at least one of carbon nanotubes (CNTs), graphene and ceramic nanoparticles; conductive PVDF including at least one of carbon black and silver (Ag) nanoparticles; and resin-blended PVDF in which a polymer other than PVDF is mixed, and preferably may include PVDF-TrFE. However, it is not particularly limited to this, and any type of the PVDF-based polymer may be used.

Referring to [FIG. 6], which illustrates the dielectric constant (Er) according to the dielectric particle: PVDF-based polymer (using PVDF-TrFE polymer) based on the weight ratio (the total of the weight ratios is 10), the preferred parts by weight of the dielectric particle 141 and the PVDF-based polymer 142 for improving the dielectric characteristics are explained, that the dielectric layer 111 may preferably include the PVDF-based polymer 142 in an amount greater than 0 and less than 42.86 parts by weight based on 100 parts by weight of dielectric particle 141.

Referring to [Table 1] illustrating the results of external stress strain evaluation according to the parts by weight of PVDF-based polymer (using PVDF-TrFE polymer) based on 100 parts by weight of dielectric particles, the preferred parts by weight of dielectric particles 141 and PVDF-based polymer 142 are explained, it may be preferred that the dielectric layer 111 includes the PVDF-based polymer 142 in an amount exceeding 17.65 parts by weight based on 100 parts by weight of dielectric particles 141.

TABLE 1

| | |
|---|---|
| Parts by Weight of PVDF- | |
| based polymer based on | Deformation |
| 100 parts by weight of | under external |
| dielectric particles | stress of 5N |

| | | | | |
|---|---|---|---|---|
| 900 | Parts by Weight | 10 | mm | — |
| 400 | Parts by Weight | 10 | mm | — |
| 233.33 | Parts by Weight | 10 | mm | — |
| 150 | Parts by Weight | 10 | mm | — |
| 100 | Parts by Weight | 10 | mm | — |
| 66.67 | Parts by Weight | 9.3 | mm | — |
| 42.86 | Parts by Weight | 7.9 | mm | — |
| 25 | Parts by Weight | 7.2 | mm | — |
| 17.65 | Parts by Weight | 2 | mm | Half-break |
| | | | | after 2 mm |
| | | | | deformation |
| 11.11 | Parts by Weight | 0 | mm | No deformation |

Alternatively, it may be more preferable that the dielectric layer 111 includes the PVDF-based polymer 142 in an amount of greater than 17.65 parts by weight and less than 42.86 parts by weight based on 100 parts by weight of dielectric particles 141, and it may be most preferable that the dielectric layer 111 includes the PVDF-based polymer 142 in an amount of 25 parts by weight based on 100 parts by weight of dielectric particles 141.

When the dielectric layer 111 includes the PVDF-based polymer 142 in a weight ratio of greater than 0 and less than 42.86 parts based on 100 parts by weight of dielectric particles 141, the dielectric characteristics may be further improved, and the dielectric particles: PVDF-based polymer may be greater than 7:3 and less than 10:0 based on the weight ratio (the total of the weight ratios is 10).

When the dielectric layer 111 contains greater than 42.86 parts by weight of PVDF-based polymer 142 based on 100 parts by weight of dielectric particles 141, the effect of improving dielectric characteristics may not be excellent.

When the dielectric layer 111 contains greater than 17.65 parts by weight of the PVDF-based polymer 142 based on 100 parts by weight of dielectric particles 141, the flexural strength characteristics may be further improved, and the dielectric particles: PVDF-based polymer may be greater than 0:10 and less than 8:2 based on the weight ratio (the total of the weight ratios is 10).

When the dielectric layer 111 contains the PVDF-based polymer 142 in an amount of 17.65 parts by weight or less, based on 100 parts by weight of the dielectric particles 141, the ductility may be insufficient, resulting in insufficient viscoelasticity imparted to the dielectric layer 111.

When the dielectric layer 111 contains the PVDF-based polymer 142 in a part by weight exceeding 17.65 and less than 42.86 based on the part by weight of the dielectric particles 100, the dielectric characteristics may be improved and the bending strength characteristics may be excellent. The number of parts by weight of PVDF-based polymer based on 100 parts by weight of the dielectric particles may correspond to the number of parts by weight of the PVDF-based polymer used to prepare the dielectric layer. The number of parts by weight of the PVDF-based polymer may be based on 100 parts by weight of dielectric powder used to prepare the dielectric layer.

Meanwhile, in order to distinguish the dielectric layers included in the cover portions 112 and 113 and side margin portions 114 and 115 described later, the dielectric layer included in the capacitance formation portion Ac may be defined as a first dielectric layer, the dielectric layer included in the cover portions 112 and 113 may be defined as a second dielectric layer, and the dielectric layer included in the side margin portions 114 and 115 may be defined as a third dielectric layer.

In addition, the dielectric particles 141 and the PVDF-based polymer 142 of the first dielectric layer 111 may be applied to the second dielectric layer and/or the third dielectric layer, but are not particularly limited thereto.

A thickness td of the dielectric layer 111 is not particularly limited.

In order to ensure reliability of the multilayer electronic component 100 under a high-voltage environment, the thickness td of the dielectric layer 111 may be 10.0 μm or less, 9.0 μm or less, 8.0 μm or less, 7.0 μm or less, 6.0 μm or less, or 5.0 μm or less. In addition, in order to implement miniaturization and high capacitance of the multilayer electronic component 100, the thickness td of the dielectric layer 111 may be 3.0 μm or less. In order to more easily implement miniaturization and high capacitance, the thickness td of the dielectric layer 111 may be 1.0 μm or less, preferably 0.6 μm or less, and more preferably 0.4 μm or less.

Here, the thickness td of the dielectric layer 111 may mean the thickness td of the dielectric layer 111 disposed between the first and second internal electrodes 121 and 122.

In this case, the thickness td of the dielectric layer 111 may be a concept including the thickness td of any one of a plurality of dielectric layers 111, or may be a concept including the thickness td of each of all dielectric layers 111.

In addition, the thickness td of the dielectric layer 111 may mean the average thickness td of one dielectric layer 111, may mean an average thickness td of each of the plurality of dielectric layers 111, or may mean the average thickness td of the plurality of dielectric layers 111.

The average thickness td of the dielectric layer 111 may be measured by scanning an image of a cross-section in the length and thickness direction of the body 110 using a field emission scanning electron microscope (FE-SEM) at 10,000× magnification. More specifically, the average thickness td of one dielectric layer 111 may mean an average value calculated by measuring the thickness of one dielectric layer 111 at 5 points equally spaced apart in the longitudinal direction in a scanned image. The 5 points equally spaced apart from each other may be designated in the capacitance formation portion Ac. In addition, by extending this average value measurement to 3 dielectric layers 111 and calculate the average value, the average thickness td of the plurality of dielectric layers 111 may be further generalized.

The internal electrodes 121 and 122 may be alternately stacked with the dielectric layer 111.

The internal electrodes 121 and 122 may include the first internal electrode 121 and the second internal electrode 122, and the first and second internal electrodes 121 and 122 are alternately disposed to face each other with the dielectric layer 111 constituting the body 110 interposed therebetween, and may be exposed to the third and fourth surfaces 3 and 4 of the body 110, respectively.

More specifically, the first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third side 3 of the body 110 and connected to the first internal electrode 121, and a second external electrode 132 may be disposed on the fourth side 4 of the body 110 and connected to the second internal electrode 122.

That is, the first internal electrode 121 may be connected to the first external electrode 131 without being connected to the second external electrode 132, and the second internal electrode 122 may be connected to the second external electrode 132 without being connected to the first external electrode 131. In this case, the first and second internal electrodes 121 and 122 may be electrically separated from each other by a dielectric layer 111 disposed in the middle.

Meanwhile, the body 110 may be formed by alternately stacking a first ceramic green sheet printed with a paste for a first internal electrode, which will become the first internal electrode 121, and a second ceramic green sheet printed with a paste for a second internal electrode, which will become the second internal electrode 122, and then firing the stacked. A printing method of the conductive paste for the internal electrode may use a screen printing method or a gravure printing method, but the present disclosure is not limited thereto.

The material forming the internal electrodes 121 and 122 is not particularly limited, and a material with excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti) and alloys thereof, and may further include carbon (C) or a material including carbon (C) (e.g., graphene).

Meanwhile, in the present disclosure, the internal electrodes 121 and 122 may include silver (Ag) as a main component metal.

That the internal electrodes 121 and 122 include silver (Ag) as a main component metal may mean that the internal electrodes 121 and 122 include silver (Ag) as a main component among the metals included in the internal electrodes 121 and 122, and may further include at least one of the aforementioned other metals, for example, copper (Cu) and carbon (C), other than silver (Ag).

As a more specific example, the internal electrodes 121 and 122 may include silver (Ag) as a conductive material, or may include a material including silver (Ag) and carbon (C), or may include silver (Ag) and copper (Cu).

When the internal electrodes 121 and 122 contain silver (Ag), the resistance is approximately 10~30 mΩ/□, and heat treatment is preferably performed at approximately 200° C. or lower, when the internal electrodes 121 and 122 contain silver (Ag) and carbon (C), the resistance is approximately 40 mΩ/□, and heat treatment is preferably performed at approximately 130° C. or lower, and when the internal electrodes 121 and 122 contain silver (Ag) and copper (Cu), the resistance is approximately 200 mΩ/□, and heat treatment is preferably performed at approximately 150° C. or lower.

Here, □ means square, can be a unit representing sheet resistance, and can be independent of the length unit. Sheet resistance is an index measuring the size of resistance regardless of thickness in a thin film material (e.g., internal electrodes, etc.), and may mean that a constant resistance value is maintained in a square unit regardless of the size of the length, and sheet resistance may be expressed as Rₛ=ρ/t (Rₛ: mΩ/□, ρ is a resistivity of the material (Ω·m), t: a thickness of the internal electrode (m)).

In addition, in embodiments, the term “main component” may indicate a component occupying a relatively large weight ratio, atomic number ratio, or molar number ratio compared to other components, and may indicate a component exceeding 50 wt % or greater based on the weight of the entire composition of a specific member or configuration (e.g., internal electrode, external electrode) including the main component, a component that is 50 at % or greater based on the atomic number, or a component that is 50 mol % or greater based on the molar number.

Meanwhile, the thickness the of the internal electrodes 121 and 122 are not particularly limited, and the description of the thickness the of the internal electrodes 121 and 122 below may mean the thickness the of each of the first internal electrode 121 and the second internal electrode 122.

In order to ensure reliability of the multilayer electronic component 100 under a high-voltage environment, the thickness the of the internal electrodes 121 and 122 may be 3.0 μm or less. Additionally, in order to implement miniaturization and high capacitance of the multilayer electronic component 100, the thickness the of the internal electrodes 121 and 122 may be 1.0 μm or less. In order to more easily implement miniaturization and high capacitance, the thickness the of the internal electrodes 121 and 122 may be 0.6 μm or less, and more preferably 0.4 μm or less.

In this case, the thickness the of the internal electrodes 121 and 122 may be a concept including the thickness the of at least one of the plurality of internal electrodes 121 and 122, or may be a concept including the thickness the of all internal electrodes 121 and 122.

At this time, the thickness the of the internal electrodes 121 and 122 may be a concept including the thickness the of at least one of the plurality of internal electrodes 121 and 122, or may be a concept including the thickness the of each of all internal electrodes 121 and 122.

In addition, the thickness the of the inner electrodes (121 and 122) may mean the average thickness the of one internal electrodes 121 and 122, or may mean an average thickness the of each of the plurality of internal electrodes 121 and 122, or may mean an average thickness the of the plurality of internal electrodes 121 and 122.

The average thickness the of the internal electrodes 121 and 122 may be measured by scanning an image of a cross-section of the length and thickness direction of the body 110 with a field emission scanning electron microscope (FE-SEM) at 10,000× magnification. More specifically, the average thickness the of one internal electrodes 121 and 122 may be an average value calculated by measuring the thickness of one internal electrode at 5 points equally spaced apart in the longitudinal direction in the scanned image. The 5 points equally spaced apart may be designated in the capacitance formation portion (Ac). In addition, by extending this average value measurement to 3 internal electrodes 121 and 122 and calculating the average value, the average thickness the of plurality of internal electrodes 121 and 122 may be further generalized.

Meanwhile, in an embodiment of the present disclosure, the thickness td of at least one of the plurality of dielectric layers 111 and the thickness the of at least one of the plurality of internal electrodes 121 and 122 may satisfy 2×te<td.

In other words, the thickness td of one dielectric layer 111 may be greater than twice the thickness the of one internal electrodes 121 and 122. Preferably, the average thickness td of the plurality of dielectric layers 111 may be greater than twice the average thickness the of the plurality of internal electrodes 121 and 122).

In general, a reliability issue due to a decrease in the breakdown voltage (BDV) under a high-voltage environment may be a major issue for high-voltage electronic components.

Accordingly, in order to prevent a decrease in the breakdown voltage under a high-voltage environment, the breakdown voltage characteristics may be improved by configuring the average thickness td of the dielectric layer 111 greater than twice the average thickness the of the internal electrodes 121 and 122.

When the average thickness td of the dielectric layer 111 is less than twice the average thickness the of the internal electrodes 121 and 122, the breakdown voltage may decrease and a short may occur between the internal electrodes.

Meanwhile, the body 110 may include cover portions 112 and 113 disposed on both end-surfaces of the capacitance formation portion Ac in the thickness direction.

Specifically, the body 110 may include a first cover portion 112 disposed on one surface of the capacitance formation portion Ac in the thickness direction and a second cover portion 113 disposed on the other surface of the capacitance formation portion Ac in the thickness direction. More specifically, for example, the body 110 may include the first cover portion 112 disposed on a lower portion of the capacitance formation portion Ac in the thickness direction and a second cover portion 113 disposed on an upper portion of the capacitance formation portion Ac in the thickness direction.

The first cover portion 112 and the second cover portion 113 may be formed by disposing or stacking a single second dielectric layer or two or more second dielectric layers on the upper and lower surfaces of the capacitance formation portion Ac in the thickness direction, respectively, and may prevent damage to the internal electrodes 121 and 122 due to physical or chemical stress.

The first cover portion 112 and the second cover portion 113 may not include internal electrodes 121 and 122 and may include the same dielectric material as the first dielectric layer 111 of the capacitance formation portion Ac. That is, the first cover portion 112 and the second cover portion 113 may include a dielectric material, for example, a barium titanate (BaTiO₃)-based dielectric material.

Meanwhile, the thickness tc of the cover portions 112 and 113 may not need to be particularly limited, and a description of the thickness tc of the cover portions 112 and 113 may mean the thickness tc of each of the first cover portion 112 and the second cover portion 113.

However, in order to easily implement miniaturization and high capacitance of the multilayer electronic component 100, the thickness tc of the cover portions 112 and 113 may be 100 μm or less or 50 μm or less, preferably 30 μm or less, and more preferably 20 μm or less in ultra-small products.

Here, the thickness tc of the cover portions 112 and 113 may mean the average thickness of the cover portions 112 and 113.

Additionally, the average thickness tc of the cover portions 112 and 113 may mean the average thickness tc of each of the first and second cover portions 112 and 113, or may mean the average thickness tc of the first and second cover portions 112 and 113.

The average thickness tc of the cover portions 112 and 113 may be measured by scanning an image of a cross-section of the body 110 in the length and thickness direction using a scanning electron microscope (SEM) at 10,000× magnification. More specifically, it may mean an average value calculated by measuring the thickness at 5 points equally spaced apart in the longitudinal direction in an image scanned of one cover portions 112 and 113.

In addition, the average thickness tc of the cover portions 112 and 113 measured by the above-described method may have a value substantially the same as the average thickness of the cover portions 112 and 113 in the cross-section of the body 110 in the width and thickness direction.

Meanwhile, the multilayer electronic component 100 may include a side margin portions 114 and 115, which is a width-wise end region of the internal electrodes 121 and 122.

More specifically, the side margin portions 114 and 115 may include a first side margin portion 114 disposed between the internal electrodes 121 and 122 and the fifth surface 5 and a second side margin portion 115 disposed between the internal electrodes 121 and 122 and the sixth surface 6.

As illustrated, the side margin portions 114 and 115 may refer to a region between the width-wise ends of the first and second internal electrodes 121 and 122 and the boundary surface of the body 110, based on the cross-section of the body 110 in the width and thickness directions.

The side margin portions 114 and 115 may refer to a ceramic green sheet region excluding the internal electrodes 121 and 122 when the internal electrode paste is applied onto the ceramic green sheet for the capacitance formation portion Ac, excluding regions corresponding to the side margin portions 114 and 115.

However, it is not particularly limited thereto, and the side margin portions 114 and 115 may be formed by applying a conductive paste to the ceramic green sheet applied to the capacitance formation portion Ac, other than the region in which the side margin portions 114 and 115 may be formed, thereby forming internal electrodes 121 and 122, and in order to suppress a step difference caused by the internal electrodes 121 and 122, the body 110 may be cut so that the internal electrodes 121 and 122 after stacking to be exposed to the fifth and sixth surfaces 5 and 6 of the body 110, and then a single third dielectric layer or two or more third dielectric layers may be formed by disposing or stacking them on both end-surfaces of the capacitance formation portion Ac in the width direction.

The side margin portions 114 and 115 may basically contribute to prevent damage to the internal electrodes 121 and 122 due to physical or chemical stress.

The side margin portions 114 and 115 may not include the internal electrodes 121 and 122, and may include the same material as the first dielectric layer 111. That is, the first side margin portion 114 and the second side margin portion 115 may include a dielectric material, for example, a barium titanate (BaTiO₃)-based dielectric material.

Meanwhile, a width wm of the side margin portions 114 and 115 may not need to be particularly limited, and the description of the width wm of the side margin portions 114 and 115 may mean a width wm of the first side margin portion 114 and the second side margin portion 115, respectively.

In order to easily implement miniaturization and high capacitance of the multilayer electronic component 100, the width wm of the side margin portions 114 and 115 may be 50 μm or less, preferably 30 μm or less, and may be more preferably 20 μm or less in ultra-small products.

Here, the width wm of the side margin portions 114 and 115 may mean an average width wm of the side margin portions 114 and 115.

Additionally, the average width wm of the side margin portions 114 and 115 may mean the average width wm of each of the first and second side margin portions 114 and 115, or may mean an average width wm of the first and second side margin portions 114, 115.

The average width wm of the side margin portions 114 and 115 may be measured by scanning an image of a cross-section of the body 110 in the width and thickness direction using a scanning electron microscope (SEM) at 10,000× magnification. More specifically, it may mean an average value calculated by measuring the width at 5 points equally spaced apart in the thickness direction in an image scanned of one side margin portions 114 and 115.

In an embodiment of the present disclosure, a structure in which the multilayer electronic component 100 may have two external electrodes 131 and 132 is described, but the number or shape of the external electrodes 131 and 132 may be varied depending on the form of the internal electrodes 121 and 122 or other purposes.

The external electrodes 131 and 132 may be disposed on the body 110 and may be connected to the internal electrodes 121 and 122.

More specifically, the external electrodes 131 and 132 may be disposed on the third and fourth surfaces 3 and 4 of the body 110, respectively, and may include first and second external electrodes 131 and 132 connected to the first and second internal electrodes 121 and 122, respectively. That is, the first external electrode 131 may be disposed on the third surface 3 of the body and may be connected to the first internal electrode 121, and the second external electrode 132 may be disposed on the fourth surface 4 of the body and may be connected to the second internal electrode 122.

Additionally, the external electrodes 131 and 132 may extend and be disposed on portions of the first and second surfaces 1 and 2 of the body 110, or may extend and be disposed on portions of the fifth and sixth surfaces 5 and 6 of the body 110. That is, the first external electrode 131 may be disposed on the third surface 3 of the body 110 and a portion of the first, second, fifth, and sixth surfaces 1, 2, 5, and 6 of the body 110, and the second external electrode 132 may be disposed on the fourth surface 4 of the body 110 and a portion of the first, second, fifth, and sixth surfaces 1, 2, 5, and 6 of the body 110.

The external electrodes 131 and 132 may be formed of any material having electrical conductivity, such as metal, and a specific material may be determined in consideration of electrical characteristics and structural stability, or the like, and may include an electrode layer. Furthermore, the electrode layer may have a multilayer structure.

For example, the external electrodes 131 and 132 may include a first electrode layer 131a and 131b disposed on the body 110, and further include a second electrode layer 131b and 132b disposed on the first electrode layer 131a and 132a, and a third electrode layer 131c and 132c disposed on the second electrode layer 131b and 132b.

Here, it may be desirable for the first to third electrode layers to correspond to distinct layers. However, it is not particularly limited to this, and may be distinguished according to the order of the manufacturing process, and at least some of the layers among the first to third electrode layers may not be distinguished from each other and may be observed as one layer.

In the present disclosure, the term “distinguished” may mean that two layers are distinguished due to physical differences, chemical differences, and/or simple optical differences, and is not particularly limited thereto, but the distinction between layers may be identified by the presence or absence of an “interface.” The term “interface” may mean a surface where two layers in contact with each other are distinguishable from each other, and may mean a state where they can be distinguished by differences in components, such as through EDS analysis using equipment such as a scanning electron microscope (SEM).

The first electrode layers 131a and 132a may be formed by transferring a sheet including a conductive metal onto the body 110, or may be formed by applying a conductive paste for an external electrode including a conductive metal to the body 110 and then performing sintering, or may be formed by dipping the body 110 into a conductive paste for an external electrode including a conductive metal, but is not particularly limited thereto.

The first electrode layers 131a and 132a may include a first conductive metal and glass.

A material having excellent electrical conductivity may be used as the conductive metal included in the first electrode layers 131a and 132a, and for example, the conductive metal may include one or more selected from a group consisting of nickel (Ni), copper (Cu), palladium (Pd), silver (Ag), gold (Au), platinum (Pt), tin (Sn), tungsten (W), titanium (Ti), and alloys thereof, and may further include carbon (C) or a material including carbon (C) (e.g., graphene), but is not particularly limited thereto.

Meanwhile, in the present disclosure, the external electrodes 131 and 132 may include silver (Ag) as the main component metal, and more specifically, the first electrode layers 131a and 132a may include silver (Ag) as the main component metal.

That is, the internal electrodes 121 and 122, and the first electrode layers 131a and 132a may have the same main component metal, for example, the internal electrodes 121 and 122, and the first electrode layers 131a and 132a may include silver (Ag) as the main component metal.

That the first electrode layers 131a and 132a include silver (Ag) as a main component metal may mean that the first electrode layers 131a and 132a include silver (Ag) as a main component among the metals included in the first electrode layers 131a and 132a, and may further include at least one of the aforementioned other metals, for example, copper (Cu) and carbon (C), other than silver (Ag).

To give a more specific example, the first electrode layers 131a and 132a may include silver (Ag) as a conductive material, or may include a material including silver (Ag) and carbon (C), or may include silver (Ag) and copper (Cu).

When the first electrode layers 131a and 132a contain silver (Ag), the resistance is about 10 to 30 mΩ/□, and it is preferable to perform the heat treatment at about 200° C. or lower. When the internal electrodes 121 and 122 contain silver (Ag) and carbon (C), the resistance is about 40 mΩ/□, and it is preferable to perform the heat treatment at about 130° C. or lower. When the internal electrodes 121 and 122 contain silver (Ag) and copper (Cu), the resistance is about 200 mΩ/□, and it may be preferable to perform the heat treatment at about 150° C. or lower.

After applying the external electrodes 131 and 132 including the first electrode layers 131a and 132a, a heat treatment, sintering, must be performed. If a temperature of about 200° C. or higher is applied, the PVDF-based polymer 142 included in the body 110 may be deformed, thereby reducing the bending stress. To prevent these problems from occurring, it may be desirable to limit the heat treatment temperature.

The glass included in the first electrode layers 131a and 132a may improve bonding with the body 110, and is not particularly limited as long as it may improve bonding with the body 110.

Meanwhile, in the present disclosure, the external electrodes 131 and 132 may not include resin.

In the case of a multilayer ceramic capacitor for an electrical field, excellent bending strength is required, and for this purpose, resin is added to the external electrodes 131 and 132 to impart viscoelasticity, thereby preventing cracks from occurring in the body 110. However, in the present application, since a PVDF-based polymer 142 having excellent viscoelasticity is included in the dielectric layer 111, cracks may be prevented from occurring in the body 110 even if an electrode layer including resin is not formed in some of the external electrodes 131 and 132.

However, it is not particularly limited thereto, and in an environment requiring better bending stress, (0 conductive resin layer including resin may be formed on the external electrode 131, and for example, a conductive resin layer including a conductive metal and resin may be included on the first electrode layers 131a and 132a.

The resin included in the conductive resin layer may contribute to improve flexural strength, and is not particularly limited as long as it can be mixed with the conductive metal included in the conductive resin layer to make a paste, and may include, for example, an epoxy resin.

The second electrode layers 131b and 132b, and the third electrode layers 131c and 132c may contribute to improve the mounting characteristics, and may be a plating layer sequentially formed on the first electrode layers 131a and 132a by plating, but are not particularly limited thereto.

The types of the second electrode layers 131b and 132b, and the third electrode layers 131c and 132c are not particularly limited, and may include, for example, at least one of nickel (Ni), tin (Sn), silver (Ag), palladium (Pd), and alloys thereof.

More specifically, for example, the second electrode layers 131b and 132b, and the third electrode layers 131c and 132c, a nickel (Ni) electrode layer and a tin (Sn) electrode layer or a tin (Sn) electrode layer and a nickel (Ni) electrode layer may be sequentially formed on the first electrode layers 131a and 132a.

There is no need to specifically limit the size of the multilayer electronic component 100.

However, in order to maintain excellent reliability under a high-voltage environment, the dielectric layers and internal electrodes must be thickened to increase the breakdown voltage BDV characteristics, so the effect of the present disclosure may be more noticeable in a multilayer electronic component 100 having a size of 2012 (length×width: 2.0 mm×1.2 mm, length and width satisfy an error of ±10%) or greater. Additionally, the multilayer electronic component 100 may have a width greater than a length.

Although the embodiments of the present disclosure have been described in detail above, the present disclosure is not limited by the above-described embodiments and the accompanying drawings, and is intended to be limited by the appended claims. Therefore, various forms of substitution, modification, and change will be possible by those skilled in the art within the scope of the technical spirit of the present disclosure described in the claims, which also falls within the scope of the present disclosure.

In addition, the expression ‘one embodiment’ used in the present disclosure does not mean the same embodiment, and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment, and are not intended to limit the disclosure. In this case, singular expressions include plural expressions unless the context clearly indicates otherwise.

While the embodiments have been illustrated and described above, it will be configured as apparent to those skilled in the art that modifications and variations could be made without departing from the scope of the present disclosure as defined by the appended claims.

What is claimed is:

1. A multilayer electronic component comprising:
a body including a dielectric layer and internal electrodes; and
an external electrode disposed on the body,
wherein the dielectric layer includes a plurality of dielectric particles and a polyvinylidene fluoride (PVDF)-based polymer.

2. The multilayer electronic component of claim 1, wherein the dielectric layer comprises the PVDF-based polymer in an amount of more than 0 and less than 42.86 parts by weight based on 100 parts by weight of the plurality of dielectric particles.

3. The multilayer electronic component of claim 1, wherein the dielectric layer comprises the PVDF-based polymer in an amount of more than 17.65 parts by weight based on 100 parts by weight of the plurality of dielectric particles.

4. The multilayer electronic component of claim 1, wherein the dielectric layer comprises the PVDF-based polymer in an amount of more than 17.65 parts by weight and less than 42.86 parts by weight based on 100 parts by weight of the plurality of dielectric particles.

5. The multilayer electronic component of claim 1, wherein a major axis length of a dielectric particle among the plurality of dielectric particles is 50 nm or more and 1000 nm or less.

6. The multilayer electronic component of claim 1, wherein the plurality of dielectric particles are in a pulverized form.

7. The multilayer electronic component of claim 1, wherein the PVDF-based polymer is disposed between adjacent dielectric particles among the plurality of dielectric particles.

8. The multilayer electronic component of claim 1, wherein the PVDF-based polymer comprises at least one selected from the group consisting of PVDF homopolymer; PVDF-HFP (Hexafluoropropylene); PVDF-TrFE (Trifluoroethylene); PVDF-CTFE (Chlorotrifluoroethylene); PVDF-TFE (Tetrafluoroethylene); surface-modified PVDF comprising PVDF-g-PEG (Polyethylene Glycol), PVDF-g-PS (Polystyrene), or both; Fluoroelastomer-based PVDF; PVDF-nanocomposite comprising (i) carbon nanotubes (CNT), (ii) graphene, (iii) ceramic nanoparticles, or any combination of (i) to (iii); conductive PVDF comprising carbon black, silver Ag nanoparticles, or both; and resin-blended PVDF mixed with a polymer other than PVDF.

9. The multilayer electronic component of claim 1, wherein the internal electrodes include a main component metal, and the main component metal includes silver Ag.

10. The multilayer electronic component of claim 9, wherein the internal electrode further comprises copper Cu, carbon C, or both.

11. The multilayer electronic component of claim 1, wherein the external electrode is disposed on the body and includes a first electrode layer connected to the internal electrodes,
wherein the first electrode layer includes a main component metal, and the main component metal includes silver Ag.

12. The multilayer electronic component of claim 11, wherein the first electrode layer further includes copper Cu, carbon C, or both.

13. The multilayer electronic component of claim 1, wherein main metal components of the internal electrodes and the external electrode are the same.

14. The multilayer electronic component of claim 11, wherein the external electrode further includes a second electrode layer disposed on the first electrode layer, and a third electrode layer disposed on the second electrode layer,
wherein the second and third electrode layers include at least one selected from the group consisting of nickel Ni, tin Sn, silver Ag, and palladium Pd.

15. The multilayer electronic component of claim 1, wherein the external electrode is free of resin.

16. The multilayer electronic component of claim 13, wherein the main metal components of the internal electrodes and the external electrode include silver Ag.
